(19) United States
(12) Patent Application Publication
(10) Pub. No.: US 2007/0095795 A1
(43) Pub. Date: May 3, 2007

(54) Assembly fixture and method for machining injection mold tooling

(75) Inventors: Guido Drees, Lubbecke (DE); Ralf Drees, Lubbecke (DE); Heinrich Meinert, Hille (DE); Martin Gerber, Langnau i.E. (CH); Erich Greber, Kriens (CH); Guido Bernet, Sempach (CH)

Correspondence Address: WARE FRESSOLA VAN DER SLUYS &;ADOLPHSON, LLP, BRADFORD GREEN, BUILDING 5, 755 MAIN STREET, P O BOX 224, MONROE, CT, 06468, US

(73) Assignee: Nokia Corporation

(21) Appl. No.: 11/261,076

(22) Filed: Oct. 27, 2005

(51) Int. Cl. B23H 9/12; B23H 1/00

(52) U.S. Cl. 219/69.11

(57) ABSTRACT

An assembly fixture is used to hold the moveable mold half insert assembly (e.g. the insert, cores, lifters, ejector pins, etc.) in its correct working position and orientation. To spark erode the final geometric form onto a moveable mold half insert assembly, the assembly fixture can be placed in an electro or electrical discharge machine (EDM) with the moveable mold half insert assembly therein.

### TECHNICAL FIELD

The present invention relates generally to injection molding and deals more particularly with an assembly fixture and method for machining injection mold tooling.

### BACKGROUND OF THE INVENTION

It is known in plastic injection molding that the moveable mold half insert assembly (comprised of the insert, cores, lifters and ejector pins) assembled onto the mold base forms the moveable mold half of the mold. To spark erode the final geometric form onto the moveable mold half insert assembly, this moveable mold half of the mold can be placed in an electro or electrical discharge machine (EDM) with the moveable mold half insert assembly (comprised of the insert, cores, lifters and ejector pins) in its correct working position and orientation on the mold base. However, the machining of the entire moveable mold half of the mold requires a large electro discharge machine. Accordingly, it would be a great advantage to provide a fixture which could hold the moveable mold half insert assembly during the electro discharge machining process so a smaller electro discharge machine could be utilized.

### SUMMARY OF THE INVENTION

It is an object of the present invention to provide a novel assembly fixture and method for using the same for machining injection mold tooling.

It is also an object of the present invention to provide a simple and inexpensive means and method of machining injection mold tooling.

It a further object to provide such an assembly fixture which may be readily and economically fabricated and will enjoy a long life in operation.

It has now been found that the foregoing and related objects can be readily attained in an assembly fixture for use in holding a moveable mold half insert assembly in its correct working position and orientation for spark eroding a final geometric form onto the moveable mold half insert assembly. The assembly fixture includes a base and an upstanding structure mounted on the base for supporting the moveable mold half insert assembly and defining a cavity into which a portion of the moveable mold half insert assembly extends.

Desirably, the base includes at least one robot handling component adapted for engagement by a robot to pick up the assembly fixture and the moveable mold half insert assembly thereon.

According to the invention, the base can also include at least one measuring machine alignment component thereon to permit the assembly fixture and the moveable mold half insert assembly thereon to be accurately placed in a measuring machine used to precisely align the moveable mold half insert assembly in its correct working position and orientation prior to spark erosion and to check measurements on the moveable mold half insert assembly after spark erosion.

In still another feature of the invention, the moveable mold half insert assembly has components chosen from the group consisting of insert, cores, lifters and ejector pins.

In practicing the method of the present invention, the moveable mold half insert assembly is mounted on the upstanding structure of the assembly fixture with a portion of the moveable mold half insert assembly received in the cavity in correct working position and orientation for spark eroding a final geometric form onto the moveable mold half insert assembly.

The invention will be fully understood when reference is made to the following detailed description taken in conjunction with the accompanying drawings.

### BRIEF DESCRIPTION OF THE DRAWINGS

FIG. 1 is a moveable mold half insert assembly in an assembly fixture embodying the present invention;

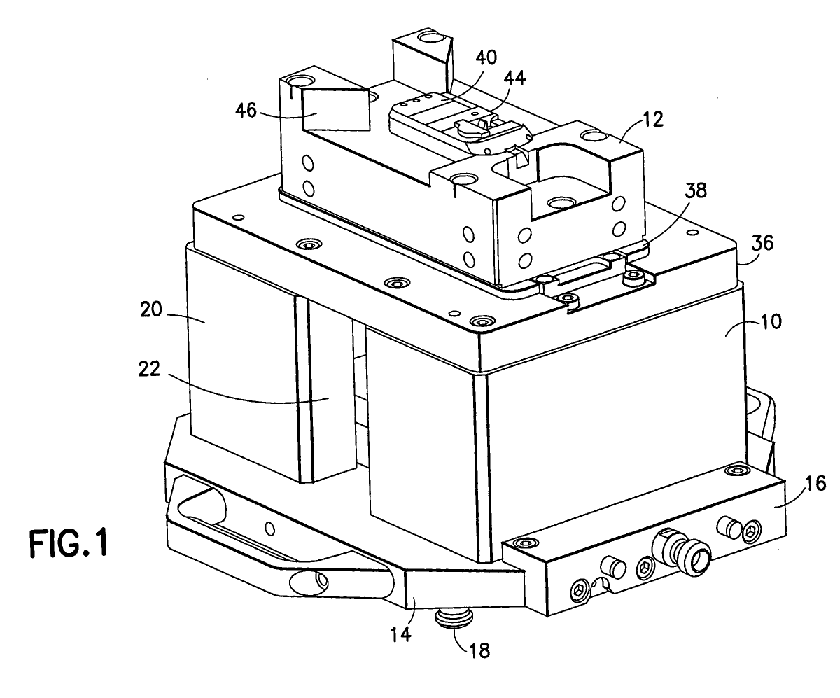

FIG. 2 is a side view of the moveable mold half insert assembly and the assembly fixture illustrated in FIG. 1; and

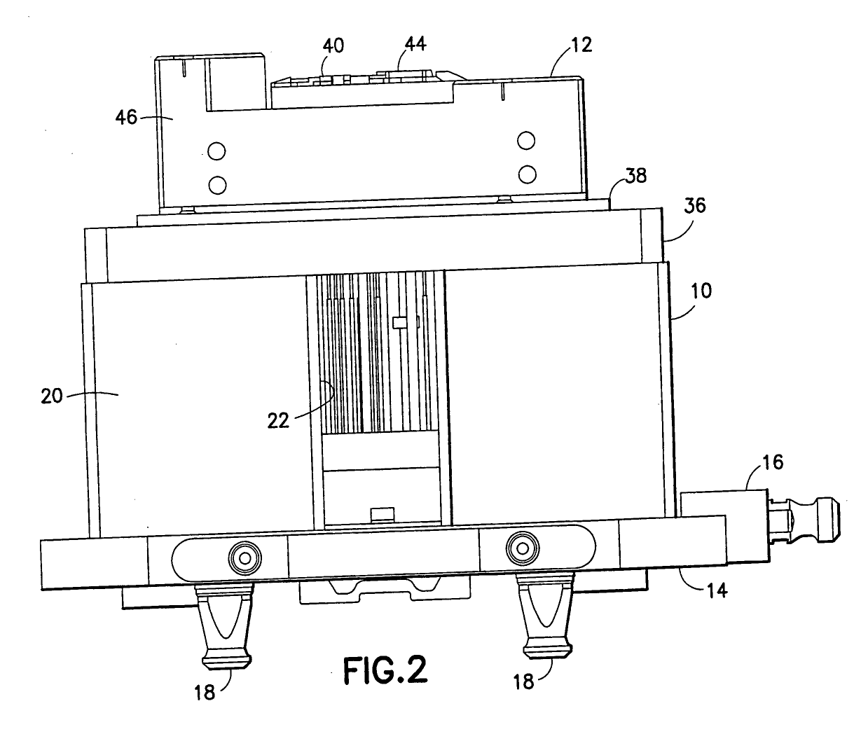

FIG. 3 is a cross-sectional view of the moveable mold half insert assembly and the assembly fixture illustrated in FIG. 1.

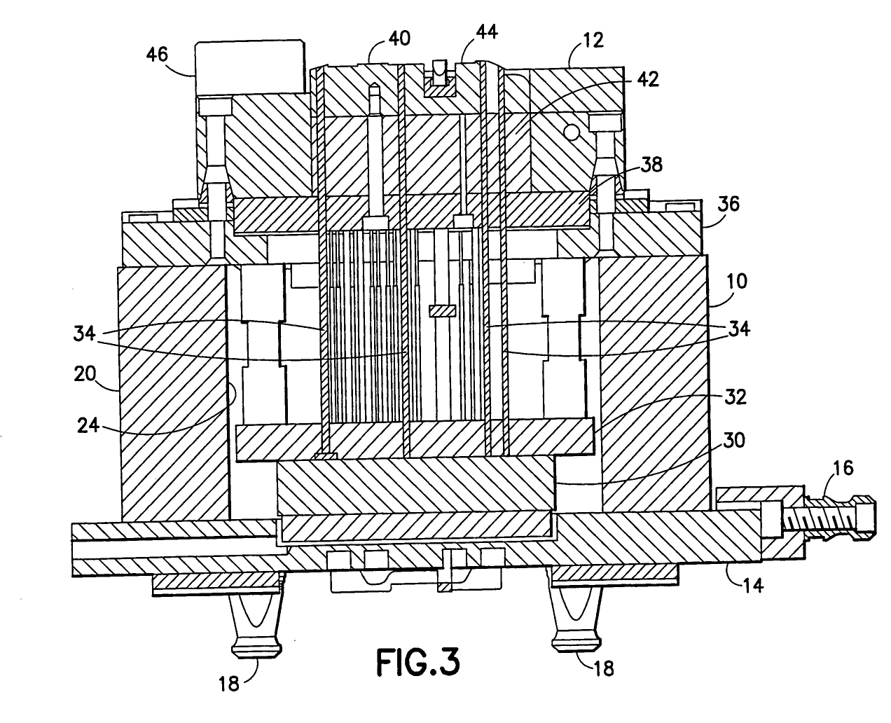

### DETAILED DESCRIPTION OF PREFERRED EMBODIMENTS

Turning now to the drawings and considering the invention in further detail, a moveable mold half assembly fixture 10 is illustrated therein and is designed for holding a moveable mold half insert assembly 12 during an electro discharge machining process. The moveable mold half assembly which is illustrated is used in the manufacture of components for cellular phones such as device covers for cellular phones. The moveable mold half assembly fixture 10 has a base plate 14 manufactured by Erowa System Technolgien GmbH of Cadolzburg, Germany. At one end, the base plate 14 is provided with a robot handling component 16 which allows a robot (not shown) to pick up the moveable mold half assembly fixture 10 and moveable mold half insert assembly 12 and place them in the electro discharge machine (not shown). The base plate 14 also has spaced apart measuring machine alignment components 18 extending from the bottom side thereof to permit the moveable mold half assembly fixture 10 and the moveable mold half insert assembly 12 to be accurately placed in a measuring machine used to precisely align the moveable mold half insert assembly 12 in its correct working position and orientation prior to the electro discharge machining process and to check measurements on the moveable mold half insert assembly 12 after the electro discharge machining process. The upper side of the moveable mold half assembly fixture 10 supports an upstanding structure 20 providing an access port 22 and cavity 24.

As will be appreciated by those skilled in the art, the moveable mold half insert assembly 12 has moveable mold half ejector plate 30 and moveable mold half ejector retainer plate 32 which hold moveable mold half pin ejectors 34 in position during the electro discharge machining process and drive the moveable hold half pin ejectors 34 during the molding process. The moveable mold half insert assembly 12 also has a moveable mold half support plate 36 which retains a moveable mold half guiding plate 38 which locates a core 40. The core 40 defines the features of the plastic parts to be molded and is the portion of the mold where there are protrusions on which the molded plastic parts shrink and adhere during the opening of the mold. The moveable mold half pin ejectors 34 are used to push the molded parts from the core 40. The core 40 has a core bottom portion 42 and core top portion 44 which are surrounded by a moveable mold half insert 46. The moveable mold half insert assembly 12 can also have lifters (not shown) which are commonly used for molding larger parts having localized undercuts. The lifters would be moved by the moving mold half ejector plate 30 to drive sections of the core 40 at angle to the mold and away from the molded part to thus relieve the undercuts.

In use, the moveable mold half insert fixture 10 is a universal fixture which allows a complete moveable mold half insert assembly 12 (34, lifters, 40 and 46) to be held in its correct position and orientation in an electro discharge machine so the moveable mold half insert assembly 12 can undergo an electro discharge machining process. The moveable mold half insert fixture 10 with the moveable mold half insert assembly 12 mounted therein can also be aligned for location in a measurement machine. The advantage gained from machining the moveable mold half insert assembly 12 in this manner is that a smaller electro discharge machine may be used and thus the manufacturing process is easier and less costly. Accordingly, the present invention provides an advantage over the prior art by providing the ability to simplify the machining processes in comparison to the processes required for machining an entire moveable mold half. A further advantage is realized from the reduced the manufacturing cost since the moveable mold half insert fixture 10 can be universal and reusable for all different types of moveable mold half insert assemblies 12.

The preferred embodiment described above admirably achieves the objects of the invention. However, it will be appreciated that departures can be made by those skilled in the art without departing from the spirit and scope of the invention which is limited only the following claims.

What is claimed is:

1. An assembly fixture for use in holding a moveable mold half insert assembly in its correct working position and orientation for spark eroding a final geometric form onto the moveable mold half insert assembly, the assembly fixture comprising:
a base; and
an upstanding structure mounted on the base for supporting the moveable mold half insert assembly and defining a cavity into which a portion of the moveable mold half insert assembly extends.

2. The assembly fixture as defined in claim 1, wherein the base includes at least one robot handling component adapted for engagement by a robot to pick up the assembly fixture and the moveable mold half insert assembly thereon.

3. The assembly fixture as defined in claim 1, wherein the base includes at least one measuring machine alignment component thereon to permit the assembly fixture and the moveable mold half insert assembly thereon to be accurately placed in a measuring machine used to precisely align the moveable mold half insert assembly in its correct working position and orientation prior to spark erosion and to check measurements on the moveable mold half insert assembly after spark erosion.

4. The assembly fixture as defined in claim 1, wherein the moveable mold half insert assembly has components chosen from the group consisting of insert, cores, lifters and ejector pins.

5. The assembly fixture as defined in claim 1, wherein the moveable mold half insert assembly is adapted to produce a component for cellular phones.

6. The assembly fixture as defined in claim 5, wherein the component is a device cover.

7. Method for machining a moveable mold half insert assembly comprising the steps of:
providing an assembly fixture comprising a base and an upstanding structure mounted on the base for supporting the moveable mold half insert assembly and defining a cavity adapted to receive a portion of the moveable mold half insert assembly; and
mounting the moveable mold half insert assembly on the upstanding structure with a portion of the moveable mold half insert assembly received in the cavity in correct working position and orientation for spark eroding a final geometric form onto the moveable mold half insert assembly.

8. The method as defined in claim 7, wherein the base includes at least one robot handling component adapted for engagement by a robot to pick up the assembly fixture and the moveable mold half insert assembly thereon.

9. The method as defined in claim 7, wherein the base includes at least one measuring machine alignment component thereon to permit the assembly fixture and the moveable mold half insert assembly thereon to be accurately placed in a measuring machine used to precisely align the moveable mold half insert assembly in its correct working position and orientation prior to spark erosion and to check measurements on the moveable mold half insert assembly after spark erosion.

10. The method as defined in claim 7, wherein the moveable mold half insert assembly has components chosen from the group consisting of insert, cores, lifters and ejector pins.

11. The method as defined in claim 7, wherein the moveable mold half insert assembly is adapted to produce a component for cellular phones.

12. The method as defined in claim 1 1, wherein the component is a device cover.
